(19) United States
(12) Patent Application Publication
(10) Pub. No.: US 2009/0012879 A1
(43) Pub. Date: Jan. 8, 2009

(54) SYSTEM AND METHOD FOR ELECTRONIC PAYMENT USING SEPARATED TIMING AND INTERFACE

(76) Inventor: Hyun-il Choi, Victoria (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/774,529

(22) Filed: Jul. 6, 2007

(51) Int. Cl. G06Q 30/00

(52) U.S. Cl. 705/27

(57) ABSTRACT

An electronic payment system includes a receiver for receiving order information which includes order numbers and the settlement accounts for the product and the service ordered by a first client or a second client from an affiliated store system. A first transmitter is provided for transmitting settlement request information which includes settlement accounts for the ordered product and service to a second client making payment on behalf of a first client. A settlement processor is provided for settlement processing of the settlement accounts through a settlement unit selected by the second client by interworking with the second client. A second transmitter is provided for transmitting settlement processing results to the second client and the affiliated store system.

### FIELD

The present invention relates to an electronic payment system where one individual makes payment on behalf of another.

### BACKGROUND

The present invention generally relates to an electronic settlement system and a method thereof, and more specifically, to an electronic settlement system and a method thereof capable of processing product information inquiry, order, and settlement through dualization, by performing a process of inquiring about and ordering information of a product to be purchased and a process of settling accounts of an ordered product among E-commerce processes, for at least separate time or in separate spaces.

In the past, a method of paying for and settling accounts of a product was used while a purchaser and a seller directly confronted each other during product transactions. However, as communication technology such as the Internet and terminal technology have been developed, various E-commerce services for paying for and settling accounts of products as inquiring about and ordering product information have been provided with no need for purchasers to confront sellers. Specially, in case of such an E-commerce service, a purchaser can use the service even without directly visiting a store or an office of a seller or without using a determined terminal (ATM in case of banking) in any place where the purchaser can connect to a network such as the Internet, thus there are no restrictions on space. Furthermore, as an automatic electronic coping system is introduced, the service can be used without the temporal limit. As a result, the E-commerce service has been developed and spread at high speed thanks to the economical advantages of store procurement and reduction in distribution cost. In addition, along with development of security aspects and speed of wireless Internet technology as well as mobile communication terminal technology including portable phones, a method of providing such a prior E-commerce service by interworking the E-commerce service with mobile communication terminals has been suggested and is currently developing fast.

The prior E-commerce service consists of inquiry, order, and settlement processes of product information. First, if a purchaser uses contents provided by an affiliated store system or inquires about and selects information on a marketing product to order the product while he or she is connected with the affiliated store system (seller) through a network, a process for settling accounts of the product is mainly carried out on a screen of the same apparatus in a continuous way. The settlement process is executed by a PG (Payment Gateway) interworking with the affiliated store system or a system which conducts a similar task, and more specifically, it is performed by an electronic wallet module of the system which conducts the similar task or the PG (Payment Gateway) installed in an APP or ActiveX type within a web server of the affiliated store system. If the purchaser inquires about product information and orders a product, the PG interworking with the affiliated store system or the system that performs the similar task, and the electronic wallet module are driven to directly connect the purchaser with the PG or the system that performs the similar task, then settlement is conducted after the purchaser is authenticated by using an electronic certificate or another authentication unit. If the purchaser inputs a lot of settlement-related information such as credit card, bank account, and prepaid card data, the PG or the system that performs the similar task receives settlement information, and transmits or demands settlement authentication-related settlement information for the corresponding settlement to an equivalent financial institution such as a bank or a credit card company capable of being linked, then receives approval to send settlement results to a customer as approving the settlement for the affiliated store system.

At least order and settlement processes among product information inquiry, order, and settlement processes of the above E-commerce service are continuously handled, and the processes are characteristic from a point of view that a subject for handling the product information inquiry, order, and settlement processes becomes the purchaser. Even though the affiliated store system provides a service of temporarily storing product information selected by the purchaser through a storage process such as a market basket, it just executes an operation of temporarily keeping the information for a procedure of continuously progressing product information inquiry, order, and settlement.

Therefore, in the prior E-commerce service, at least order and settlement processes are not fully separated from each other in terms of space and time and should be continuously performed, thus the prior service is hampered by restrictions that the purchaser has to directly handle most of product information inquiry, order, and settlement. So, it is impossible to lead various transformations of the service, which the purchaser can only pay for a product after entrusting product information inquiry and order to a third party or the purchaser can only pay for the product by using another apparatus of the purchaser later after the purchaser himself or herself inquires about product information and orders the product. In a concrete way, services capable of purchasing products or services for modern people who are busy are being recently popularized. However, in order for a third party (proxy) to purchase or pay for a product, the purchaser should offer settlement information such as a credit card number to the third party (proxy) owing to restrictions on the E-commerce service where the order and settlement processes are continuously performed as mentioned above. And, this produces a serious security problem. Also, when order and settlement processes cannot help being separated from each other by time and space like a product is paid at home after the purchaser inquires about product information and orders the product in an office or like a product ordered by a family member is paid through another apparatus at separate time or in separate space, the settlement process itself cannot be conducted apart from the order process. Consequently, it causes the user's inconvenience of conducting the order process again.

### SUMMARY

According there is provided An electronic payment system for conducting account settlement of products and services, by interworking with an online/offline affiliated store system that provides the products and the services. The system is used with a first client that inquires about product information which is information on the products and the services supplied by the affiliated store system and a second client that receives the product information from the affiliated store system to select and order a product and a service to be purchased and that settles accounts of the product and the service to be purchased. The electronic payment system includes a receiver for receiving order information which includes order numbers and the settlement accounts for the product and the service ordered by either the first client or the second client, from the affiliated store system. A first transmitter is provided for transmitting settlement request information which includes settlement accounts for the ordered product and service to the second client. A settlement processor is provided for settlement processing of the settlement accounts through a settlement unit selected by the second client by interworking with the second client. A second transmitter is provided for transmitting settlement processing results to the second client and the affiliated store system.

### DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a format diagram of a first embodiment of an E-commerce system applied with an electronic settlement system in accordance with the present invention;

FIG. 2 is a diagram illustrating a structure of a shopping mall database in accordance with the present invention;

FIG. 3 is a diagram illustrating a structure of a settlement database in accordance with the present invention;

FIG. 4 is a format diagram of a second embodiment of an E-commerce system applied with an electronic settlement system in accordance with the present invention;

FIG. 5 is a format diagram of a third embodiment of an E-commerce system applied with an electronic settlement system in accordance with the present invention;

FIG. 6 is a flow chart of a first embodiment of an E-commerce process applied with an electronic settlement method in accordance with the present invention;

FIG. 7 is a flow chart of a second embodiment of an E-commerce process applied with an electronic settlement method in accordance with the present invention; and

FIG. 8 is a flow chart of a third embodiment of an E-commerce process applied with an electronic settlement method in accordance with the present invention.

### DETAILED DESCRIPTION

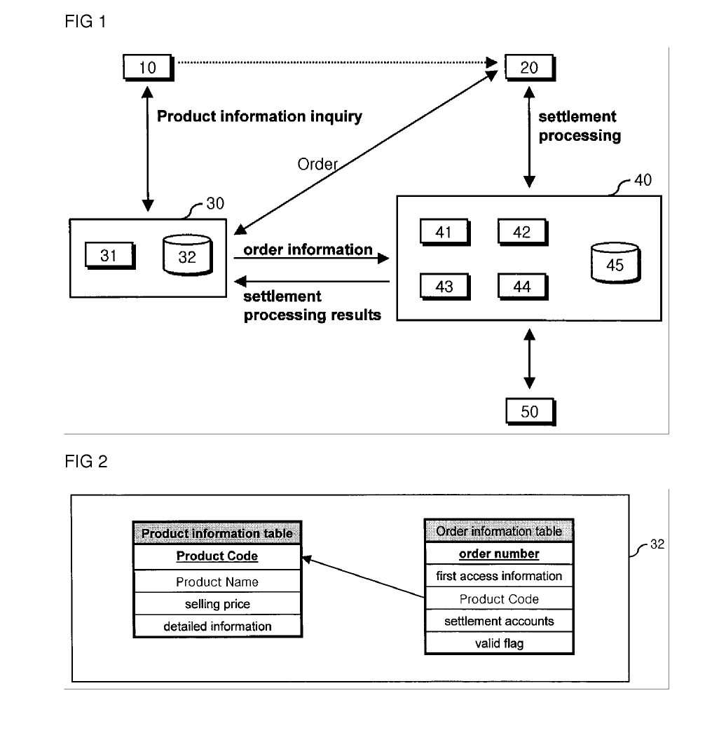

The preferred embodiment, an electronic payment system will now be described with reference to FIG. 1 through 8.

Electronic payment system in accordance with the present invention conducts account settlement of products and services by interworking with an online/offline affiliated store system that provides products and services, a first client that inquires about product information which is information on the products and services supplied by the affiliated store system, and a second client that receives the product information from the affiliated store system to select and order a product and a service to be purchased and that settles accounts of the product and the service to be purchased, comprising: a receiver for receiving order information which includes order numbers and settlement accounts for the product and the service ordered by the second client, from the affiliated store system; a first transmitter for transmitting settlement request information which includes the settlement accounts for the ordered product and service to the second client; a settlement processor for settlement processing of the settlement accounts through a settlement unit selected by the second client by interworking with the second client; and a second transmitter for transmitting settlement processing results to the second client and the affiliated store system

In another embodiment of an electronic settlement system in accordance with the present invention, the electronic settlement system settles accounts of products and services by interworking with an online/offline affiliated store system that provides products and services, a first client group that inquires about product information which is information on the products and the services provided by the affiliated store system and that selects and orders a product and a service to be purchased, and a second client that receives settlement request information which includes settlement accounts for the ordered product and service and that processes the settlement accounts, comprising: a receiver for receiving order information which includes order numbers and settlement accounts for the product and the service ordered by the first client group, from the affiliated store system; a first transmitter for transmitting the settlement request information to the second client; a settlement processor for settlement processing of the settlement accounts through a settlement unit selected by the second client by interworking with the second client; and a second transmitter for transmitting settlement processing results to the second client and the affiliated store system.

Desirably, the first client group comprises a third client that inquires about the product information which is information on the product and the service supplied by the affiliated store system, and a fourth client that receives the product information from the affiliated store system to select and order a product and a service to be purchased. One of credit card settlement, transferring settlement, electronic cash, a prepaid card, e-mail based payment (ex, PayPal), cellular phone number based payment, and micro portable phone payment can be used as the settlement unit. The order information further contains first access information which is an intrinsic value assigned to the second client to access the second client, and the settlement request information further contains second access information for making the second client access the electronic settlement system. The first transmitter transmits the settlement request information to the second client by using the first access information. One of a portable phone number, an apparatus number, a chip serial number, an ID assigned to identify the second client from the affiliated store system, an e-mail address, and a messenger ID can be used as the first access information.

In an e-commerce system that includes an online/offline affiliated store system that provides products and services, a first client that inquires about product information which is information on the products and services supplied by the affiliated store system, a second client that receives the product information from the affiliated store system to select and order a product and a service to be purchased and that settles accounts of the product and the service to be purchased, and an electronic settlement system for conducting account settlement of the products and the services by interworking with the affiliated store system and the second client, an electronic settlement method in accordance with the present invention comprises the steps of: a product information inquiry step of the first client inquiring about the product information from the affiliated store system; a product information transmission step of transmitting the product information that the affiliated store system inquires about to the second client; an order step of the second client ordering a product and a service; and a settlement step of the electronic settlement system conducting account settlement by interworking with the second client; and wherein the settlement step comprises the steps of: a first step of receiving order information which includes order numbers and settlement accounts of a product and a service ordered by the second client, from the affiliated store system; a second step of transmitting settlement request information which includes settlement accounts for the ordered product and service to the second client; a third step of conducting settlement processing of the settlement accounts through a settlement unit selected by the second client by interworking with the second client; and a fourth step of transmitting settlement processing results to the second client and the affiliated store system.

In addition, in an e-commerce system that includes an online/offline affiliated store system that provides products and services, a first client group that inquires about product information which is information on the products and the services supplied by the affiliated store system and that selects and orders a product and a service to be purchased, a second client that receives settlement request information which includes settlement accounts of the ordered product and service and that processes the settlement accounts, and an electronic settlement system that conducts processing of the settlement accounts by interworking with the affiliated store system and the second client, another embodiment of the electronic settlement method in accordance with the present invention comprises the steps of: a product information inquiry step of the first client group inquiring about the product information from the affiliated store system; an order step of the first client group ordering the product and the service; and a settlement step of the electronic settlement system conducting account settlement by interworking with the second client; and wherein the settlement step comprises the steps of: a first step of receiving order information which includes an order number and settlement accounts of the product and the service ordered by the second client, from the affiliated store system; a second step of transmitting the settlement request information to the second client; a third step of conducting settlement processing of the settlement accounts through a settlement unit selected by the second client by interworking with the second client; and a fourth step of transmitting settlement processing results to the second client and the affiliated store system.

If communication is directly performed in various ways such as Bluetooth or RF, and NFC without using an Internet online system between an apparatus and an apparatus or between an apparatus and a bar code, the user himself or herself carries out inquiry and order under substantial circumstances between a person and a person, a personal and an apparatus, and between an information delivery medium (ex, bar code, RFID) and a person. And, if the user's own apparatus is connected for settlement, the apparatus receives order information and conducts a settlement process, thereby functioning as a second client.

Desirably, the first client group is composed of a third client that inquires about product information which is information on the products and the services supplied by the affiliated store system, and a fourth client that receives the product information from the affiliated store system to select and order a product and a service to be purchased. Furthermore, the order information received in the first step further contains first access information which is an intrinsic value assigned to the second client to access the second client, and the settlement request information transmitted in the second step further contains second access information for accessing the electronic settlement system. One of a portable phone number, an apparatus number, a chip serial number, an ID assigned to identify the second client from the affiliated store system, an e-mail address, and a messenger ID can be used as the first access information. It is desirable that the third step consists of a 3-1 step of starting a new session for the second client which is connected through communication, a 3-2 step of conducting settlement processing of the settlement accounts with a settlement unit selected by the second client, and a 3-3 step of terminating the session for the second client. In this case, after the 3-1 step, it is desirable to further comprise a 3-4 step of transmitting validity confirm request data that demands to confirm whether the order information is currently valid by including the order number, to the affiliated store system, and a 3-5 step of receiving validity confirm results of the order information from the affiliated store system, or to further comprise a 3-6 step of the affiliated store system accessing an order information table of a shopping mall database where the order information is stored, and a 3-7 step of confirming validity of the order information by loading a valid flag value indicating whether each piece of the order information is currently valid, from the order information table by setting the order information to keys.

The present invention will now be described more fully hereinafter with reference to the accompanying drawings, in which preferred embodiments of the invention are shown.

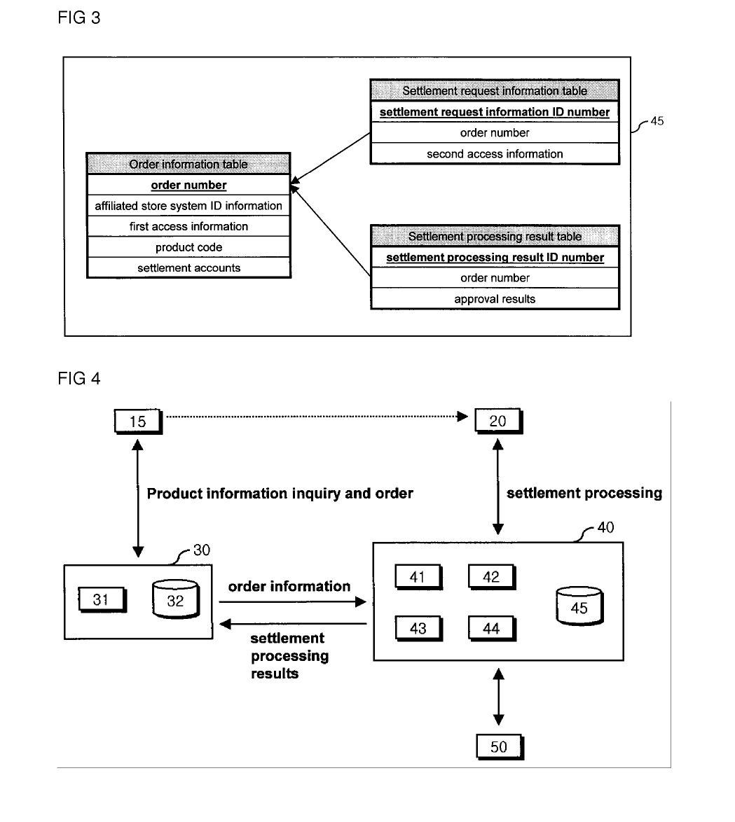

FIG. 1 is a format diagram of a first embodiment of an e-commerce system applied with an electronic settlement system in accordance with the present invention. Also, FIG. 2 is a diagram illustrating a structure of a shopping mall database in accordance with the present invention, and FIG. 3 is a diagram illustrating a structure of a settlement database in accordance with the present invention. Fields which become keys of each table are marked in bold strokes and underlines in FIG. 2 and FIG. 3. By referring to FIG. 1 to FIG. 3, configurations of the first embodiment of the e-commerce system in accordance with the present invention will be described as follows.

The first embodiment of the e-commerce system in accordance with the present invention comprises an affiliated store system (30) that sells products and services (hereinafter, commonly called ‘products’), a first client (10) that inquires about product information from the affiliated store system, a second client (20) that selects and orders a product to be purchased from the product information that the first client inquires about and that pays the product, an electronic settlement system (40) that conducts settlement processing of settlement accounts of the ordered product by interworking with the second client, and a financial institution system (50) that provides a settlement unit to the second client. In the first embodiment of the e-commerce system in accordance with the present invention, the first client (10) accesses the affiliated store system (30) to inquire about the product information, and the second client (20) selects the product to be purchased from the product information that the first client inquires about and orders the selected product as paying the ordered product. Accordingly, product information inquiry, order, and settlement processes among e-commerce processes are discontinuously handled, thereby individually handling product information inquiry and order/settlement by different subjects. It is also possible that the product information inquiry and the order/settlement can be separately carried out by the same subject.

The first client (10) is supplied with the product information from the online/offline affiliated store system (30), and inquires about the information. The product information includes a serial code (product code) provided/sold by the affiliated store system (30), names, a selling price, and detailed information. The detailed information contains detailed explanations like images of each product, features, and usage. The product information inquired about and selected by the first client (10) is transmitted to the second client (20), and at this time, the transmission of the product information is carried out by the first client or the affiliated store system (30). Besides, the first client (10) provides first access information for accessing the second client (20) that will order and pay a product, to the affiliated store system (30). The first access information is an intrinsic value assigned to the second client in order to access the second client, including a portable phone number of the second client, an apparatus number, a chip serial number, an ID (login ID of the affiliated store system) assigned to the second client from the affiliated store system, an e-mail address of the second client, and a messenger ID. In case the affiliated store system (30) is an online affiliated store system such as an Internet shopping mall, a session initiated by accessing of the first client is terminated when the first client terminates accessing to the affiliated store system after inquiring about the product information and inputting the first access information.

The second client (20) receives the product information inquired about by the first client (10), selects a product to be purchased through the received product information, and orders the product by accessing the affiliated store system (30). Likewise, the second client (20) settles accounts of the product by using a settlement unit provided by the financial institution system (50). The settlement unit can be used in various types such as credit card, transferring, electronic cash, prepaid card, e-mail based payment (ex, PayPal), cellular phone number based payment, and micro portable phone payment types. Order and settlement processes of the second client (20) are executed by being temporally and spatially separated from a product information inquiry process of the first client (10). That is to say, in case the affiliated store system is an online affiliated store system such as an Internet shopping mall, a new session is initiated when the second client accesses, then the order and settlement processes are progressed. The first client (10) and the second client (20) are discriminated in FIG. 1 for just conceptual discrimination so as to clearly describe the present invention, thus it is also possible that the first client and the second client may be the same client on a substantial embodiment. Namely, it is available that one customer client accesses the affiliated store system (30) to inquire about product information and terminates the accessing to the affiliated store system, and that the client accesses the affiliated store system again to order and pay a product to be purchased. In this case, product information inquiry and order/settlement processes are performed in different sessions, and are carried out while being temporally or spatially separated from each other by the same subject.

The affiliated store system (30) sells products to the first client (10) and the second client (20), and embraces all of online/offline affiliated store systems. The affiliated store system (30) consists of a shopping mall server (31) which conducts various processes for selling products, and a shopping mall database (32) which stores data required for selling the products.

The shopping mall server (31) loads product information from the shopping mall database (32) to provide the loaded information to the first client (10), and receives first access information of the second client from the first client to transmit product information inquired about and selected by the first client to the second client. The product information includes serial codes (product codes) of each product sold by the affiliated store system (30), names, a selling price, and detailed information. Also, when the second client (20) accesses to select and order a product, the shopping mall server (31) generates order information of the ordered product to transmit the generated information to an electronic settlement system (40), then demands settlement processing. The order information contains an order number, ID information of the affiliated store system, the first access information of the second client, a product code, and settlement accounts. The order number is an intrinsic value generated by the shopping mall server (31) during product ordering of the second client (20), being used for identifying the corresponding order and the order information. The settlement accounts are money that the second client has to pay, and are calculated by adding sale proceeds of the ordered product.

The shopping mall database (32) comprises a product information table for storing data required for product information, and an order information table for storing data required for order information. The product information table individually stores product codes of each product, names, a selling price, and detailed information, while an order number, first access information of the second client, a product code of an ordered product, settlement accounts, and a valid flag are stored in the order information table. The valid flag is a value indicating whether the order information is valid, showing whether an order can be validly processed, for instance, whether the corresponding order information is maintained without being cancelled by the second client or whether the stock of an ordered product exists or is obtainable.

The electronic settlement system (40) receives the order information from the affiliated store system (30), and processes settlement of product accounts by interworking with the second customer client (20). The electronic settlement system (40) comprises a receiver (41) for receiving the order information from the affiliated store system (30), a first transmitter (42) for transmitting settlement request information to the second client (20), a settlement processor (43) for processing the settlement of the product accounts by interworking with the second client, a second transmitter (44) for transmitting settlement processing results to the second client and the affiliated store system, and a settlement database (45) for storing data required for the settlement processing results and the settlement request information.

The receiver (41) receives order information of a product ordered by the second client (20) from the affiliated store system (30). Like shown above, the order information contains an order number, ID information of the affiliated store system, first access information of the second client, a product code, and settlement accounts. The received order information is stored in the settlement database (45).

The first transmitter (42) transmits the settlement request information that requests settlement to the second client (20). The settlement request information is transmitted by using the first access information of the second client, and includes an ID number of the settlement request information, ID information of the affiliated store system, settlement accounts that the second client has to pay, and second access information for accessing the electronic settlement system. Values included in the order information are used for the settlement accounts and the ID information of the affiliated store system. The second access information is information for enabling the second client (20) to access the electronic settlement system (40), containing an IP address and a URL of the electronic settlement system. It is desirable that the second access information is provided in a type linked with the electronic settlement system. The settlement request information can further comprise product details which are lists of products ordered by the second client.

The settlement processor (43) conducts settlement processing for the settlement accounts by interworking with the second client (20). When the second client (20) accesses the electronic settlement system (40) through the second access information of the settlement request information, the settlement processor (43) receives selection for a settlement unit for processing the settlement accounts by interworking with the second client, and authenticates the second client through a used method among various authentication methods. The settlement unit embraces credit card, transferring, electronic cash, prepaid card, e-mail based payment (ex, PayPal), and micro portable phone payment types. Furthermore, the settlement processor (43) demands settlement to the financial institution system (50) which provides the selected settlement unit, and completes the settlement by receiving approval from the financial institution system. The settlement processor (43) stores results of the approval of the financial institution system (50) in the settlement database (45).

Meanwhile, it is desirable that the settlement processor (43) confirms whether order information on the corresponding settlement is valid before the second client (20) accesses to conduct the settlement. Validity confirmation of the order information is executed when the settlement processor (43) transmits validity confirm request data which contains an order number to the affiliated store system (30) and receives validity confirm results from the affiliated store system. Order information validity confirmation of the affiliated store system (30) is conducted by confirming a valid flag of the order information table of the shopping mall database (32). At this moment, if the order information is not valid, the settlement processor (43) terminates the settlement processing after transmitting a message indicative of invalidity of the order information to the second client. In the meantime, when the settlement processor (43) interworks by installing a separate module in the affiliated store system (30) such as an electronic wallet, the settlement processor can confirm validity of the order information by directly accessing the order information table of the shopping mall database of the affiliated store system to load a valid flag.

The second transmitter (44) transmits the settlement processing results to the second client (20) and the affiliated store system (30). The settlement processing results contain an ID number of the settlement processing results, settlement accounts, and approval results. The settlement processing results transmitted to the second client (20) include ID information of the affiliated store system, while the settlement processing results transmitted to the affiliated store system (30) include an order number.

The settlement database (45) is composed of an order information table for storing order information, a settlement request information table for storing data essential for generation and transmission of the settlement request information, and a settlement processing result table for storing data necessary for generation and transmission of the settlement processing results. The order information table stores the order information received from the affiliated store system (30), and specifically, it stores an order number, ID information of the affiliated store system, first access information, a product code, and settlement accounts. The settlement request information table stores the data required for generation and transmission of the settlement request information, and specifically, it stores a settlement request information ID number, an order number, and second access information. The settlement request information table loads the affiliated store system ID information and the settlement accounts from the order information table to include the loaded information in the settlement request information, in reference to the order information table by setting the order number to a reference key, and loads the first access information so that the settlement request information is transmitted to the second client. Moreover, in case the settlement request information is included in product details, the product code can be loaded from the order information table and be included in the settlement request information. The settlement processing result table stores the data required for generation and transmission of the settlement processing results, and specifically, it stores a settlement processing result ID number, an order number, and approval results of the financial institution system (50). The settlement processing result table can also load the affiliated store system ID information, the first access information, and the settlement accounts, in reference to the order information table by setting the order number to a reference key.

The financial institution system (50) provides a settlement unit to the second client (20), and conducts settlement processing of the settlement accounts according to a settlement request of the settlement processor (43) of the electronic settlement system (40). A credit card company, a bank, a mobile communication company, and an electronic cash provider can be included in the financial institution system (50).

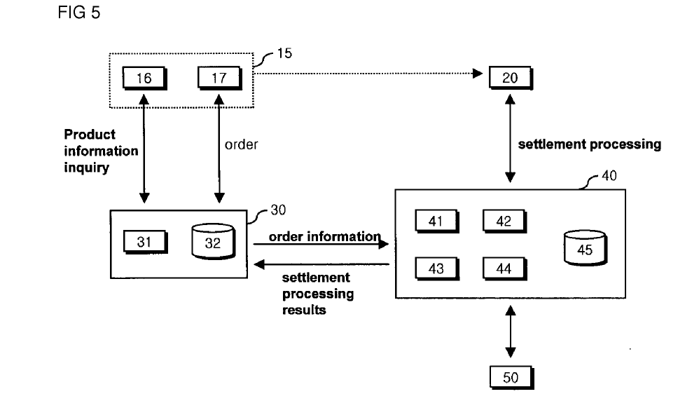

FIG. 4 is a format diagram of a second embodiment of an e-commerce system applied with an electronic settlement system in accordance with the present invention. Like shown in FIG. 4, the second embodiment of the e-commerce system in accordance with the present invention is an embodiment where product information inquiry, order, and settlement processes are discontinuously carried out by different clients, and wherein a first client group (15) accesses an affiliated store system (30) to inquire about product information and selects and orders a product to be purchased, while a second client (20) conducts processing only of settlement accounts for the ordered product. That is, the second client (20) immediately receives settlement request information from an electronic settlement system (40), and processes settlement only of the product ordered by the first client group. At this point, first access information of the second client is inputted from the first client group. Therefore, product information inquiry/order and settlement processes among e-commerce processes are executed by being temporally and spatially separated by different subjects. The first client group (15) and the second client (20) are discriminated in FIG. 4 for just conceptual discrimination so as to clearly describe the present invention, thus it is also possible that the first client group and the second client may be the same client on a substantial embodiment. Namely, it is available that one customer client accesses the affiliated store system (30) to inquire about and order product information and terminates the accessing to the affiliated store system, and that the client processes settlement accounts of an ordered product by using settlement request information transmitted from the electronic settlement system (40). In this case, product information inquiry/order and settlement processes are performed by being temporally and spatially separated by the same subject. Since another configuration of the second embodiment of the e-commerce system is the same as shown above, detailed explanations will be omitted.

FIG. 5 is a format diagram of a third embodiment of an e-commerce system applied with an electronic settlement system in accordance with the present invention. Like shown in FIG. 5, the third embodiment of the e-commerce system in accordance with the present invention is an embodiment where all of product information inquiry, order, and settlement processes are individually executed by different clients, and wherein a first client group (15) includes a third client (16) and a fourth client (17), and the third client accesses an affiliated store system (30) to inquire about product information while the fourth client selects a product to be purchased from the product information inquired about by the third client, and orders the selected product. The product information inquiry process of the third client and the order process of the fourth client are carried out in separate sessions. A second client (20) receives settlement request information from an electronic settlement system (40), and processes settlement of the product ordered by the fourth client (17). At this time, first access information of the second client is inputted from the fourth client. So, all of product information inquiry, order, and settlement processes among e-commerce processes are conducted in different sessions by separate subjects. On the other hand, the third client (16), the fourth client (17), and the second client (20) are discriminated in FIG. 5 for just conceptual discrimination so as to clearly describe the present invention, thus it is also possible that the third client, the fourth client, and the second client can be the same client on a substantial embodiment. In other words, it is available that one customer client accesses the affiliated store system (30) to inquire about product information and terminates the accessing to the affiliated store system, and the client accesses the affiliated store system again to select and order a product to be purchased from the inquired product information and terminates the accessing again, and that the client processes settlement accounts of the ordered product by using settlement request information transmitted from the electronic settlement system (40) later on. In this case, product information inquiry, order and settlement processes are performed in different sessions, and are carried out by being spatio-temporally separated from each other by the same subject. Since another configuration of the third embodiment of the e-commerce system is the same as shown above, detailed explanations will be omitted.

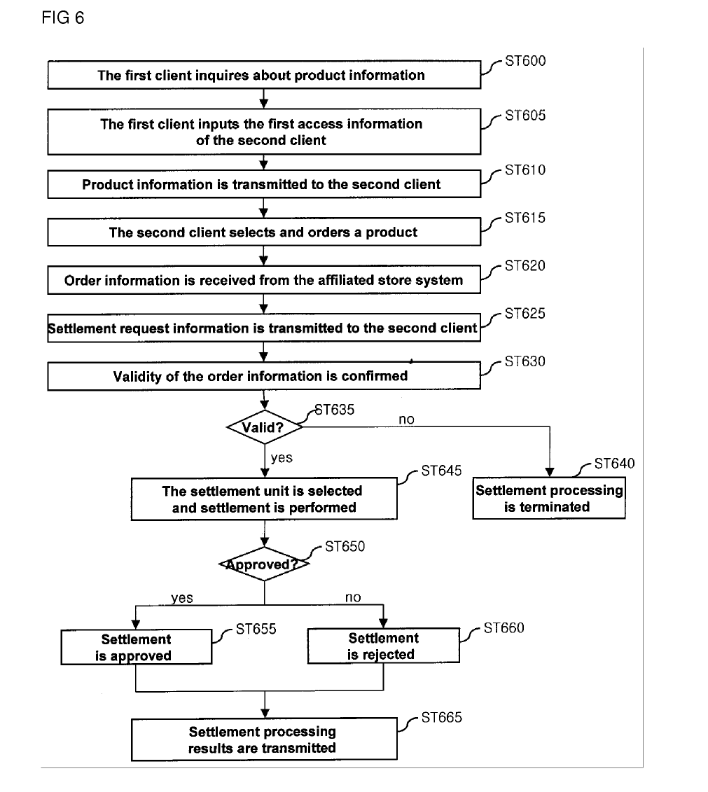

FIG. 6 is a flow chart of a first embodiment of an e-commerce process applied with an electronic settlement method in accordance with the present invention. By referring to FIG. 6, the first embodiment of the e-commerce process applied with the electronic settlement method in accordance with the present invention will be described as follows.

The first client (10) accesses the affiliated store system (30) to inquire about product information provided by the shopping mall server (31) (ST600). The product information contains product codes of each product, names, a selling price, and detailed information, and is provided by being loaded from the product information table of the shopping mall database (32). Also, the first client (10) inputs the first access information of the second client (20) to the shopping mall server (31), and the shopping mall server transmits the product information inquired about by the first client to the second client by using the first access information (ST605, ST610). The first access information contains a portable phone number, an apparatus number, a chip serial number, an ID (login ID of the affiliated store system) of the affiliated system, an e-mail address, and a messenger ID. The steps ‘ST600’ and ‘ST605’ are performed in one session initiated when the first client (10) accesses the affiliated store system (30), and the corresponding session is also terminated if the first client terminates the accessing to the affiliated store system.

The second client (20) accesses the affiliated store system (30), and selects a product to be purchased from the product information inquired about by the first client (10) to order the selected product (ST615). The step ‘ST615’ is also conducted in a new session initiated when the second client (20) accesses the affiliated store system (30), and at this moment, it is needless to say that the new session is different from the session where the steps ‘ST600’ and ‘ST605’ are carried out.

The shopping mall server (31) transmits order information to the electronic settlement system (40), and the receiver (41) receives the order information to store the received information in the order information table of the settlement database (45)(ST620). The order information includes an order number, ID information of the affiliated store system, first access information of the second client, a product code, and settlement accounts. The order number is an intrinsic serial code generated by the shopping mall server (31) when the second client (20) orders a product, and the affiliated store system and the electronic settlement system can distinguish each order and order information.

The first transmitter (42) includes details to be settled, and transmits settlement request information which demands settlement to the second client (20) (ST625). The settlement request information is transmitted to the second client by using the first access information included in the order information, and contains ID information of the affiliated store system, settlement accounts that the second client has to pay, and the second access information. It is also possible to further comprise details of the product ordered by the second client in the settlement request information. It is desirable that the second access information is provided in a type linked by access information such as a URL or an IP address for enabling the second client (20) to access the electronic settlement system (40).

When the second client (20) accesses the electronic settlement system (40) by using the second access information to demand settlement processing, the settlement processor (43) confirms validity of order information on settlement prior to the settlement (ST630). Validity confirmation of the order information is to confirm whether an order through which the settlement is to be conducted is a currently valid order, confirming whether the corresponding order can be validly processed, for instance, whether the corresponding order information is maintained without being cancelled or whether the stock of the ordered product exists or is obtainable. In order to confirm the validity of the order information, the settlement processor (43) transmits validity confirm request data which includes an order number to the affiliated store system (30), and the shopping mall server (31) loads the order information from the shopping mall database (32) by using the order number, then confirms a valid flag value of the loaded order information to send the results. In case a separate module of the electronic settlement system (40) such as an electronic wallet is installed in and interworked with the affiliated store system (30), the settlement processor (43) can directly access the shopping mall database (32) by using the order number, and can load and confirm a valid flag of the corresponding order information.

As validity confirm results, if the order information is not currently valid, the settlement processor (43) transmits a message indicating that the order information is invalid to the second client (20), and terminates the settlement processing (ST635, ST640).

As the validity confirm results, if the order information is valid, the settlement processor (43) receives selection for the settlement unit for settlement processing from the second client (20), authenticates the second client, and demands settlement to the financial institution system (50) which provides the selected settlement unit (ST635, ST645). Various settlement units such as credit card, transferring, electronic cash, prepaid card, e-mail based payment (ex, PayPal), portable phone number based payment, and micro portable phone payment types can be used as the settlement unit without any restrictions.

If the settlement request is approved from the financial institution system (50), the settlement processor (43) approves the settlement of the corresponding order information (ST650, ST655). On the contrary, if the settlement request is rejected from the financial institution system (50), the settlement processor (43) rejects the settlement of the corresponding order information (ST650, ST660). The second transmitter (44) transmits settlement processing results to the second client (20) and the affiliated store system (30) (ST665). The settlement processing results include the settlement accounts and approval results, then ID information of the affiliated store system is included in the settlement processing results transmitted to the second client (20) while the settlement processing results transmitted to the affiliated store system (30) contain the order number.

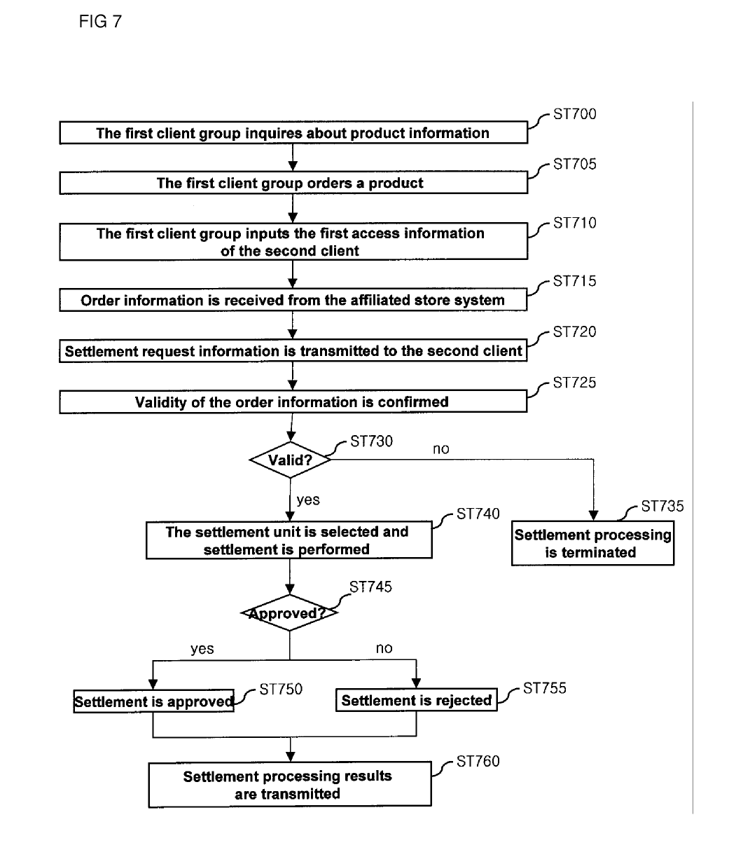

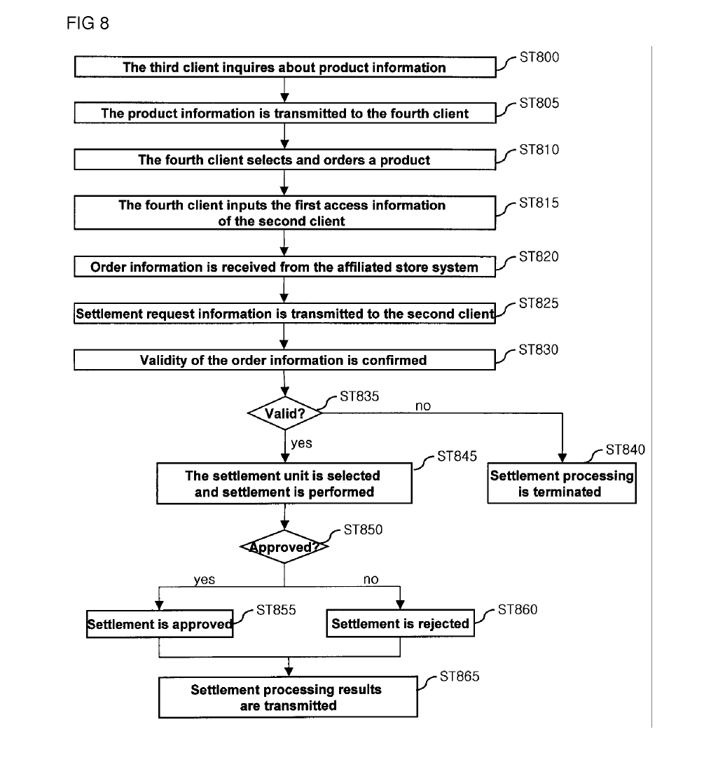

FIG. 7 is a flow chart of a second embodiment of an e-commerce process applied with an electronic settlement method in accordance with the present invention. By referring to FIG. 7, the second embodiment of the e-commerce process applied with the electronic settlement method in accordance with the present invention will be described as follows.

The first client group (15) accesses the affiliated store system (30), and inquires about product information provided by the shopping mall server (31) (ST700). And, the first client group (15) selects and orders a product to be purchased from the inquired product information, and inputs first access information of the second client (20) (ST705, ST710). The steps ‘ST700’ to ‘ST710’ are performed in one session initiated when the first client group (15) accesses the affiliated store system (30), and the session is also terminated if the first client terminates the accessing to the affiliated store system.

The receiver (41) receives order information from the shopping mall server (31), and stores the received information in the order information table of the settlement database (45), then the first transmitter (42) transmits settlement request information to the second client (20) (ST715, ST720).

When the second client (20) accesses the electronic settlement system (40) by using second access information, the settlement processor (43) confirms validity of order information to be settled (ST725). Validity confirmation of the order information is conducted by confirming a valid flag value of the order information table of the shopping mall database (32), and is carried out by transmitting validity confirm request data to the shopping mall server (31) and receiving validity confirm results or when the settlement processor (43) confirms the value by accessing the shopping mall database (32).

As validity confirm results, if the order information is not currently valid, the settlement processor (43) transmits a message to the second client (20), and terminates settlement processing (ST730, ST735).

As the validity confirm results, if the order information is valid, the settlement processor (43) receives selection for the settlement unit from the second client (20), and demands settlement to the financial institution system (50) (ST730, ST740). If the settlement request is approved from the financial institution system (50), the settlement processor (43) approves the settlement of the corresponding order information, and if the settlement request is rejected, the settlement of the corresponding order information is rejected (ST745 to ST755). The second transmitter (44) transmits settlement processing results to the second client (20) and the affiliated store system (30) (ST760).

FIG. 8 is a flow chart of a third embodiment of an e-commerce process applied with an electronic settlement method in accordance with the present invention. By referring to FIG. 8, the third embodiment of the e-commerce process applied with the electronic settlement method in accordance with the present invention will be described as follows.

The third client (16) accesses the affiliated store system (30), and inquires about product information provided by the shopping mall server (31) (ST800). The product information inquired about by the third client (16) is transmitted to the fourth client (17), and the fourth client accesses the affiliated store system (30), and selects a product to be purchased from the product information to order the selected product (ST805, ST810). Likewise, the fourth client (17) inputs first access information of the second client (20) to the affiliated store system (30) (ST815). The step ‘ST800’ is performed in a session maintained while the third client (16) accesses the affiliated store system (30), and the step ‘ST810’ is carried out in a new session maintained while the third client (16) accesses the affiliated store system (30). In other words, the steps ‘ST800’ and ‘ST810’ are executed in different sessions.

The shopping mall server (31) transmits order information to the electronic settlement system (40), and the receiver (41) receives the order information to store the received information in the order information table of the settlement database (45) (ST820). The first transmitter (42) transmits settlement request information to the second client (20) by using first access information included in the order information (ST825).

When the second client (20) accesses the electronic settlement system (40) by using second access information included in the settlement request information, the settlement processor (43) confirms validity of the order information on settlement prior the settlement (ST830). As validity confirm results, if the order information is not currently valid, the settlement processor (43) transmits a message indicating that the order information is invalid to the second client (20), and terminates settlement processing (ST835, ST840).

As the validity confirm results, if the order information is valid, the settlement processor (43) receives selection for the settlement unit from the second client (20), authenticates the second client, and demands settlement to the financial institution system (50) (ST835, ST845).

If the financial institution system (50) approves the settlement request, the settlement processor (43) approves the settlement of the corresponding order information, and if the settlement request is rejected, the settlement processor rejects the settlement of the corresponding order information, then the second transmitter (44) transmits settlement processing results to the second client (20) and the affiliated store system (30) (ST850 to ST865).

### EFFECT OF THE INVENTION

Like stated so far, an electronic settlement system and a method thereof in accordance with the present invention dualize order and settlement processes by discontinuously conducting the at least order and settlement processes in different sessions among e-commerce processes consisting of product information inquiry, order, and settlement processes, so that the product information inquiry, order, and settlement processes can be separately carried out by different clients, and wherein the same client also does not have to continuously execute the product information inquiry, order, and settlement processes, thereby temporally and spatially separating each process when necessary to freely handle the respective processes.

In accordance with the provisions of the patent statues, the present invention has been described in what is considered to represent its preferred embodiment. However, it should be noted that the invention can be practiced otherwise than as specifically illustrated and described without departing from its spirit or scope.

Reference List

| | |
|---|---|
| 10: first client | 15: first client group |
| 16: third client | 17: fourth client |
| 20: second client | 30: affiliated store system |
| 31: shopping mall server | 32: shopping mall database |
| 40: system for electronic settlement | 41: receiver |
| 42: first transmitter | 43: settlement processor |
| 44: second transmitter | 45: settlement database |
| 50: financial institution system | |

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the Claims.

What is claimed is:

1. An electronic settlement system for conducting account settlement of products and services, by interworking with an online/offline affiliated store system that provides the products and the services; a first client that inquires about product information which is information on the products and the services supplied by the affiliated store system; and a second client that receives the product information from the affiliated store system to select and order a product and a service to be purchased and that settles accounts of the product and the service to be purchased, comprising:
a receiver for receiving order information which includes order numbers and the settlement accounts for the product and the service ordered by the second client, from the affiliated store system;
a first transmitter for transmitting settlement request information which includes settlement accounts for the ordered product and service to the second client;
a settlement processor for settlement processing of the settlement accounts through a settlement unit selected by the second client by interworking with the second client; and
a second transmitter for transmitting settlement processing results to the second client and the affiliated store system.

2. An electronic settlement system for conducting account settlement of products and services, by interworking with an online/offline affiliated store system that provides the products and the services; a first client group that inquires about product information which is information on the products and the services provided by the affiliated store system and that selects and orders a product and a service to be purchased; and a second client that receives settlement request information which includes settlement accounts for the ordered product and service and that processes the settlement accounts, comprising:
a receiver for receiving order information which includes order numbers and settlement accounts for the product and the service ordered by the first client group, from the affiliated store system;
a first transmitter for transmitting the settlement request information to the second client;
a settlement processor for settlement processing of the settlement accounts through a settlement unit selected by the second client by interworking with the second client; and
a second transmitter for transmitting settlement processing results to the second client and the affiliated store system.

3. The electronic settlement system of claim 2, wherein the first client group, comprising:
a third client that inquires about the product information which is information on the product and the service supplied by the affiliated store system; and
a fourth client that receives the product information from the affiliated store system to select and order a product and a service to be purchased.

4. The electronic settlement system of one of claim 2, wherein the settlement unit is one of credit card settlement, transferring settlement, electronic cash, a prepaid card, e-mail based payment (ex, PayPal), cellular phone number based payment, and micro portable phone payment.

5. The electronic settlement system of one of claim 2, wherein the order information further contains first access information which is an intrinsic value assigned to the second client to access the second client, and the settlement request information further contains second access information for making the second client access the electronic settlement system, then the first transmitter transmits the settlement request information to the second client by using the first access information.

6. The electronic settlement system of claim 5, wherein the first access information is one of a portable phone number, an apparatus number, a chip serial number, an ID assigned to identify the second client from the affiliated store system, an e-mail address, and a messenger ID.

7. In an e-commerce system which includes an online/offline affiliated store system that provides products and services; a first client that inquires about product information which is information on the products and services supplied by the affiliated store system; a second client that receives the product information from the affiliated store system to select and order a product and a service to be purchased and that settles accounts of the product and the service to be purchased; and an electronic settlement system for conducting account settlement of the products and the services by interworking with the affiliated store system and the second client, an electronic settlement method in accordance with the present invention comprises the steps of: a product information inquiry step of the first client inquiring about the product information from the affiliated store system; a product information transmission step of transmitting the product information that the affiliated store system inquires about to the second client; an order step of the second client ordering a product and a service; and a settlement step of the electronic settlement system conducting account settlement by interworking with the second client; and wherein the settlement step, comprising the steps of:
a first step of receiving order information which includes order numbers and settlement accounts of a product and a service ordered by the second client, from the affiliated store system;
a second step of transmitting settlement request information which includes settlement accounts for the ordered product and service to the second client;
a third step of conducting settlement processing of the settlement accounts through a settlement unit selected by the second client by interworking with the second client; and
a fourth step of transmitting settlement processing results to the second client and the affiliated store system.

8. In an e-commerce system which includes an online/offline affiliated store system that provides products and services; a first client group that inquires about product information which is information on the products and the services supplied by the affiliated store system and that selects and orders a product and a service to be purchased; a second client that receives settlement request information which includes settlement accounts of the ordered product and service and that processes the settlement accounts; and an electronic settlement system that conducts processing of the settlement accounts by interworking with the affiliated store system and the second client, an electronic settlement method comprises the steps of:
a product information inquiry step of the first client group inquiring about the product information from the affiliated store system;
an order step of the first client group ordering the product and the service; and
a settlement step of the electronic settlement system conducting account settlement by interworking with the second client; and wherein the settlement step, comprising the steps of:
a first step of receiving order information which includes an order number and settlement accounts of the product and the service ordered by the first client, from the affiliated store system;
a second step of transmitting the settlement request information to the second client;
a third step of conducting settlement processing of the settlement accounts through a settlement unit selected by the second client by interworking with the second client; and
a fourth step of transmitting settlement processing results to the second client and the affiliated store system.

9. The electronic settlement method of claim 8, wherein the first client group, comprising:
a third client that inquires about product information which is information on the products and the services supplied by the affiliated store system; and
a fourth client that receives the product information from the affiliated store system to select and order a product and a service to be purchased.

10. The electronic settlement method of one of claim 7, wherein the order information received in the first step further contains first access information which is an intrinsic value assigned to the second client to access the second client, and the settlement request information transmitted in the second step further contains second access information for accessing the electronic settlement system.

11. The electronic settlement method of claim 10, wherein the first access information is one of a portable phone number, an apparatus number, a chip serial number, an ID assigned to identify the second client from the affiliated store system, an e-mail address, and a messenger ID.

12. The electronic settlement method of one of claim 7, wherein the third step, comprising the steps of:
a 3-1 step of starting a new session for the second client which is connected through communication;
a 3-2 step of conducting settlement processing of the settlement accounts with a settlement unit selected by the second client; and
a 3-3 step of terminating the session for the second client.

13. The electronic settlement method of claim 12, wherein after the 3-1 step, the third step further comprises the steps of:
a 3-4 step of transmitting validity confirm request data that demands to confirm whether the order information is currently valid by including the order number, to the affiliated store system; and
a 3-5 step of receiving validity confirm results of the order information from the affiliated store system.

14. The electronic settlement method of claim 12, wherein after the 3-1 step, the third step further comprises the steps of:
a 3-6 step of the affiliated store system accessing an order information table of a shopping mall database where the order information is stored; and
a 3-7 step of confirming validity of the order information by loading a valid flag value indicating whether each piece of the order information is currently valid, from the order information table by setting the order information to keys.

15. The electronic settlement system of claim 5, wherein when information is transmitted to the second client by using SMS, e-mail, and messenger methods from the first transmitter after the first client conducts the inquiry or the inquiry and the order, the second client can progress a next step by accessing the settlement system through a direct accessing method for information transmission.

16. The electronic settlement system of claim 5, wherein when information is transmitted to the second client by using SMS, e-mail, and messenger methods from the first transmitter after the first client conducts the inquiry or the inquiry and the order, if a menu related to the present operation is accessed to the second client or an embedded module is provided, the second client activates the menu or the module to carry out the operation by accessing the corresponding settlement system.

17. The electronic settlement system of claim 5, wherein when information is transmitted to the second client by using SMS, e-mail, and messenger methods from the first transmitter after the first client conducts the inquiry or the inquiry and the order, the second client performs the operation by directly accessing an equivalent site such as the Internet.

18. The electronic settlement system of claim 5, wherein the second client can directly receive the information through another apparatus and information media (bar code, RFID, etc.), and at this time, information delivery may be executed through the Internet or be directly executed without passing through the Internet, then the order or the settlement is carried out by receiving the information, and in this case, it has the same process that the electronic settlement system delivers the results through the second transmitter after the second client performs the operation.

19. The electronic settlement system of claim 5, wherein when the first client inquires about product information or inquires about the information and orders a product through another apparatus and information media (bar code, RFID, etc.) and transmits the information to the second client through the first transmitter, information delivery may be executed through the Internet or be directly executed without passing through the Internet, then the second client conducts the order or the settlement by receiving the information, and in this case, it has the same process that the electronic settlement system delivers the results through the second transmitter after the second client performs the operation.
